(19) United States
(12) Patent Application Publication
(10) Pub. No.: US 2015/0275940 A1
(43) Pub. Date: Oct. 1, 2015

(54) LIQUID TRANSPORT DEVICE

(71) Applicant: CANON KABUSHIKI KAISHA, Tokyo (JP)

(72) Inventor: Hideyuki Sugioka, Ebina-shi (JP)

(21) Appl. No.: 14/668,665

(22) Filed: Mar. 25, 2015

(30) Foreign Application Priority Data
Mar. 27, 2014 (JP) 2014-067028

(51) Int. Cl. F15D 1/06; H01G 9/21

(52) U.S. Cl. CPC F15D 1/06; H01G 9/21

(57) ABSTRACT

A liquid transport device includes a channel, a substrate, and a light radiation unit. A liquid containing ions is transported through the channel. The substrate is disposed at a position where the substrate is in contact with the liquid. The light radiation unit radiates light toward the substrate. In the liquid transport device, an asymmetrical temperature distribution in a direction in which the liquid is transported is produced on a surface of the substrate by the light radiated by the light radiation unit.

### BACKGROUND OF THE INVENTION

1. Field of the Invention

The present invention relates to a liquid transport device, and more specifically, relates to a liquid transport device utilizing a thermo-osmosis phenomenon caused by the electrolyte Seebeck effect.

2. Description of the Related Art

Micropumps that utilize electro-osmosis are used in the fields of micro-total analysis systems (μ-TAS), labs-on-a-chip, fluid integrated circuits (fluid ICs), and so forth for reasons that, for example, the electro-osmotic micropumps are comparatively simply structured and easily mounted in minute channels (micro-channels).

In such a situation, micropumps utilizing induced-charge electro-osmosis (ICEO) have recently received attention for reasons that, for example, the flow velocity of the liquid can be increased and chemical reaction caused between an electrode and the liquid can be suppressed due to the capability of being driven by AC.

U.S. Pat. No. 7,081,189 discloses a micropump (liquid supply device) which uses ICEO and utilizes the ICEO flow.

Meanwhile, Physical Review Letter 105, 268302 (2010) discloses the following technology of a self-propulsion-type thermophoresis element: that is, the temperature difference between two surfaces is generated by laser radiation toward a double-faced particles having metal and insulating surfaces. Thus, the particles are propelled by a thermo-osmosis phenomenon caused by the temperature difference.

The electro-osmotic pump utilizing ICEO described in U.S. Pat. No. 7,081,189 is expected to be used in the future because a large flow can be generated at low voltage without mechanically movable parts.

However, since an electro-osmosis phenomenon is utilized, it is necessary to form electrodes in the channel to apply a voltage, and in order to form complex channels such as a plurality of channels, complex wiring for electrodes is necessary. Furthermore, when the drive voltage source is disposed outside the pump, many connecting wires and connecting parts are necessary for connecting the external drive power source and the internal electrodes.

Thus, in order to simplify and reduce the size of a fluid IC such as μTAS, there exists a need for improvements.

Nowadays, in many cases, a pump that needs a large external pressure generating source is generally used as a pump that applies a drive force to a liquid for transportation.

If the above-described pump can be replaced with a small simple pump that does not need the external pressure source or the like, the cost and the size of the entire system can be reduced, and accordingly, there is a possibility of increasing the field where the fluid integrated circuit is utilized.

Physical Review Letter 105, 268302 (2010) describes self-propulsion-type thermophoresis element that propels particles by the thermo-osmosis phenomenon in accordance with the temperature difference which is generated in the particles by laser radiation. However, this occurs along a complex movement caused by the Brownian movement. Furthermore, there is no disclosure from the viewpoint of describing pump operation that forms a flow in a desired direction in a channel so as to apply a drive force for liquid transportation.

The present invention provides a liquid transport device which does not need electrodes for applying voltage to the channel and wiring and the like for the electrodes, which has a simple structure, and which is small in size.

### SUMMARY OF THE INVENTION

A liquid transport device provided according to the present invention includes a channel, a substrate, and a light radiation unit. A liquid containing ions is transported through the channel. The substrate is disposed at a position where the substrate is in contact with the liquid. The light radiation unit radiates light toward the substrate. In the liquid transport device, an asymmetrical temperature distribution in a direction in which the liquid is transported is produced on a surface of the substrate by the light radiated by the light radiation unit.

Further features of the present invention will become apparent from the following description of exemplary embodiments with reference to the attached drawings.

### BRIEF DESCRIPTION OF THE DRAWINGS

FIG. 1 is a schematic view illustrating a liquid transport device according to the present invention.

FIGS. 2A and 2B are schematic views illustrating the device illustrated in FIG. 1 in more detail.

FIGS. 3A and 3B are schematic views illustrating the device illustrated in FIGS. 2A and 2B in more detail.

FIGS. 4A to 4C are schematic views illustrating generation of a drive force in the liquid transport device according to the present invention.

FIGS. 5A and 5B are schematic views illustrating an example of a liquid transport device according to the present invention.

FIGS. 6A and 6B are schematic views illustrating another example of a liquid transport device according to the present invention.

FIGS. 7A and 7B are schematic views illustrating another example of a liquid transport device according to the present invention.

FIGS. 8A and 8B are schematic views illustrating another example of a liquid transport device according to the present invention.

### DESCRIPTION OF THE EMBODIMENTS

A liquid transport device according to the present invention will be described below with reference to the drawings.

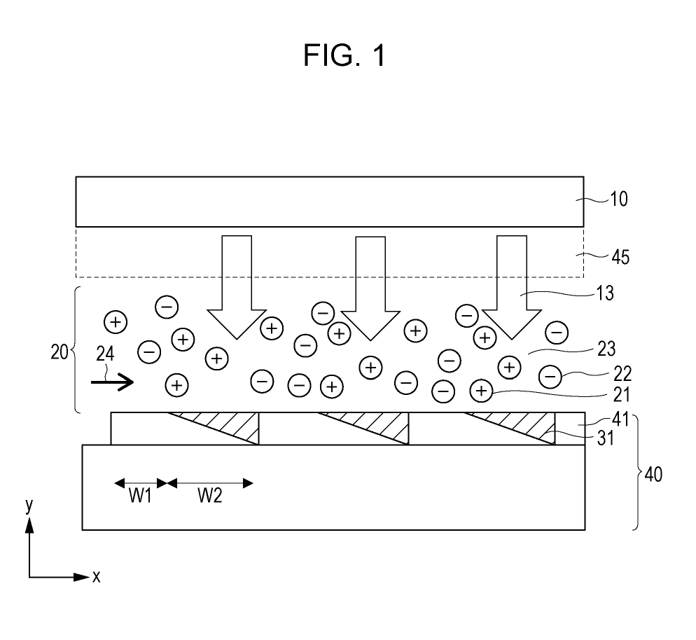

FIG. 1 is a schematic view illustrating an example of the liquid transport device according to the present invention.

The liquid transport device illustrated in FIG. 1 includes a channel 20, a substrate 40, and a light radiation unit 10. The channel 20 allows a liquid 23 that contains ions to be transported therethrough. The ions include positive ions, which are denoted by reference numeral 21, and negative ions, which are denoted by reference numeral 22. The substrate 40 is disposed at a position where the substrate 40 is in contact with the liquid 23. The light radiation unit 10 radiates light toward the substrate 40.

Reference numeral 45 denotes a transparent substrate. The transparent substrate 45 and the light radiation unit 10 face the substrate 40, so that a surface 41 of the substrate 40 is irradiated with light 13 emitted from the light radiation unit 10.

An asymmetrical temperature distribution is produced on the surface 41 of the substrate 40 in a direction 24 in which the liquid 23 is intended to be transported by the light radiation from the light radiation unit 10.

In an embodiment that produces the asymmetrical temperature distribution, the substrate 40 itself includes a surface portion 31 that produce the asymmetrical temperature distribution. This surface portion 31 can be realized by, for example, making the surface portion 31 have an asymmetrical distribution characteristic of the optical absorption coefficient. In FIG. 1, a plurality of the surface portions 31 are provided.

In FIG. 1, reference numeral W1 denotes regions having a uniform (symmetrical) optical absorption characteristic and reference numeral W2 denotes regions having an asymmetrical optical absorption characteristic.

In another embodiment that produces the asymmetrical temperature distribution on the surface 41 of the substrate 40 in the direction 24 in which the liquid 23 is intended to be transported by the light radiation from the light radiation unit 10, the light radiation unit 10 itself emits light having an asymmetrical intensity distribution.

Although the embodiment in which the substrate 40 itself includes the surface portions 31 that each produce the asymmetrical temperature distribution will be mainly described below, the present invention includes the two embodiments described above.

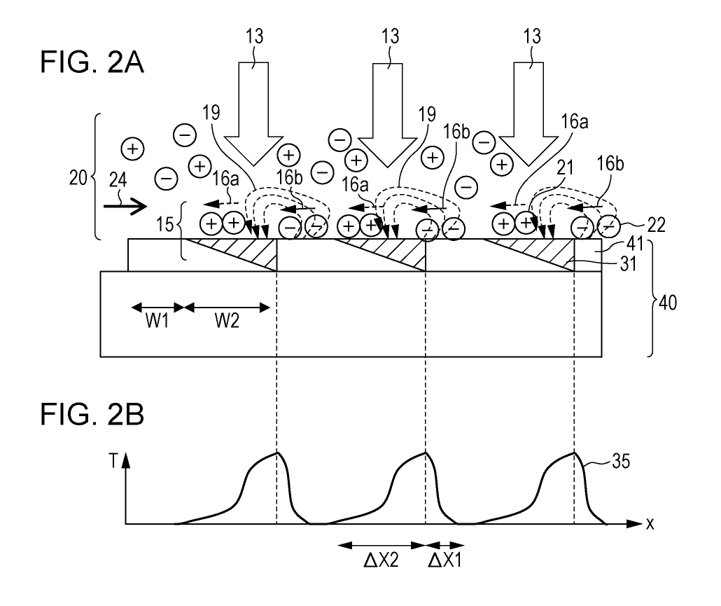

FIG. 2A is a schematic view illustrating the device illustrated in FIG. 1 in more detail. FIG. 2B is a schematic view illustrating the temperature distributions on the surface 41 of the substrate 40 receiving the light radiation 13.

Referring to FIG. 2B, the asymmetrical temperature distributions 35 corresponding to the surface portions 31 are illustrated.

In FIG. 2A, an electric double layer 15 (charges on the substrate surface attract the ions of the opposite sign) is formed by the Seebeck effect and the temperature distributions produced by the light radiation 13. Reference numerals 16a and 16b denote electric fields in tangent directions generated together with the electric double layer 15.

Reference numeral 19 denotes temperature gradient vectors at an initial stage generated due to the temperature distributions on the substrate surface. Reference numeral 24 denotes the direction in which the liquid is intended to be transported. That is, temperature gradients are generated in the liquid in the channel.

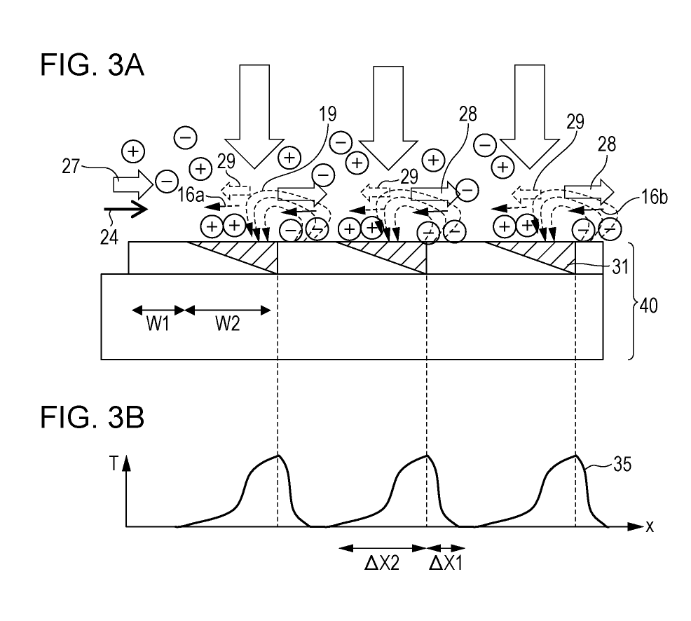

FIG. 3A is a schematic view illustrating FIG. 1 and FIG. 2A in more detail. FIG. 3B illustrates the temperature distributions on the surface 41 of the substrate 40 similarly to or in the same manner as FIG. 2B.

In FIG. 3A, reference numeral 27 denotes a direction of a net flow of the liquid generated in the channel by the light radiation. Reference numerals 28 and 29 respectively indicate slip velocities (Vs) in a forward direction and a reverse direction generated by the light radiation.

In the liquid transport device illustrated in FIGS. 1 to 3B, when the light 13 having light intensity of I(x)=g₁(x)I₀ [W/m²] is radiated to a position X of the surface 41 of the substrate 40, surface heating expressed by Q(x)=g₁(x)g₂(x)I₀ [W/m²] occurs in accordance with the optical absorption coefficient g₂(x) of the surface 41.

Due to this surface heating, in accordance with a heat conduction equation of a system, the asymmetrical surface temperature distribution f(x)=f(Q(x)) is produced in the direction 24 in which the liquid 23 is intended to be transported.

As a result, the temperature gradient vectors 19 directed from low surface temperature portions toward high surface temperature portions are generated and electric fields of E=S grad T parallel to the temperature gradient vectors are generated by the electrolyte Seebeck effect above the surface 41 of the substrate 40.

Since the channel 20 is filled with the liquid 23 containing ions, the ions contained in the liquid 23 move along the electric fields E=S grad T, so that the positive ions are gathered in parts of the surface where the temperatures are relatively high and the negative ions are gathered in parts of the surface where the temperatures are relatively low. Thus, the so-called electric double layer 15 is formed in the proximity of the surface 41 of the substrate 40.

When formation of the electric double layer begins, components of the electric fields perpendicular to the substrate surface are weakened by shielding effects of the ions. Thus, the tangent electric fields Et (16a and 16b) parallel to the substrate surface become apparent.

The ions forming the electric double layer move so as to slip along the surface of the substrate corresponding to the tangent electric fields Et and generate the slip velocities Vs outside the electric double layer.

These slip velocities Vs are generated on the high temperature sides and the low temperature sides of the surface and respectively become the forward slip velocities 28 and the reverse slip velocities 29.

Here, the symmetry of the forward flows 28 and the reverse flows 29 is broken by the asymmetry of the temperature distributions 35 in the direction 24 in which the liquid is intended to be transported, the asymmetry of the temperature distributions 35 being formed by an asymmetrical heat absorption distributions of the substrate surface or the asymmetrical intensity distributions of a light source. Thus, the net flow 27 is generated.

That is, in the liquid transport device according to the present invention, by forming the asymmetrical temperature distributions in the liquid transport direction on the substrate surface by the light radiation, the Seebeck electric fields are induced in the ion-containing liquid in contact with the surface by the temperature gradients. This forms the electric double layer and the tangent electric fields which interact with one another, thereby generating the net flow. That is, a drive force is produced.

According to the present invention, a liquid transport device which does not need electrodes for applying voltage to the channel and wiring and the like for the electrodes, which has a simple structure, and which is small in size can be provided.

The light radiation unit of the present invention may use a light source such as a laser light source, a light emitting diode (LED) light source, a fluorescent lamp light source, or a halogen lamp.

Furthermore, a two-dimensionally patterned light source, a light source having different wavelength characteristics, or a display light source provided with red, green, and blue optical filters using any of the above-described light sources can be adopted.

In particular, by generating one-dimensional or two-dimensional light output in an asymmetrical pattern similarly to a display in the liquid transport direction, desirably patterned flows can be generated in a two-dimensional channel that holds a fluid containing ions.

Furthermore, when a form of light output is focused, any of a variety of forms such as a continuous light source, a pulsed output light source, and an intermittent output light source can be adopted.

Furthermore, by using a wavelength-variable laser, heat can be generated in different absorption layers of the substrate surface, and accordingly, flows in different directions can be generated.

When intermittent laser radiation is performed, the relationship between heating and heat dissipation can be adjusted by the radiation frequency. This allows a system which is good in terms of heat cycles to be structured.

At this time, in order to form the electric double layer by the electrolyte Seebeck effect, a drive frequency of 100 KHz or lower can be used.

Examples of the material to form the substrate 40 of the present invention include glass, semiconductors such as Si, metal, paper, resin, and so forth.

The surface of the substrate in contact with the liquid can include an optical absorption layer for effectively absorbing the light.

The optical absorption layer can be formed by, for example, selectively disposing a material layer formed of a material different from that of the substrate 40 on the substrate surface or disposing a plurality of materials different from one another.

In this case, for example, the thickness of the material layer can be varied so as to produce a distribution of the optical absorption coefficient.

Examples of the optical absorption layer include a resin layer including a coloring material such as a pigment. Specifically, the distribution of the optical absorption coefficient can be produced by, for example, changing the amount of a color component included in the coloring material or changing the component itself.

Alternatively, it is useful to form a layer having an asymmetrical distribution of the optical absorption coefficient on the substrate surface by a material such as metal (for example, gold or platinum), carbon, or a carbon based material.

Furthermore, any of these surface layers may be provided with a thin protective layer. For example, an insulating film or the like may be provided on a metal such as Ta, Ti, Cu, Ag, Cr, or Ni.

Furthermore, in order to effectively generate a flow, the substrate disposed at a position in contact with the liquid in the channel may have a plurality of the surfaces on which the asymmetrical temperature distributions are produced. This may be selected by considering the width of the channel, the viscosity of the liquid to be transported, and so forth.

The surfaces where the asymmetrical temperature distributions are produced can be periodically arranged from the viewpoint of strengthening of the flow.

The shape of the surface where the asymmetrical temperature distribution is produced by the light radiation is useful from the viewpoint of hydrodynamically suppressing a flow in the reverse direction by providing the asymmetry in a direction in which a flow of the liquid is generated.

A surface on which structures having right-angled triangular sections are periodically arranged, a surface structure on which L-shaped spatial structures are periodically arranged, and the like are effective for strengthening the net flow.

When the substrate is a transparent substrate having an absorption layer disposed on its front surface (first surface), the light can be radiated through a rear surface (surface opposite to the first surface) of the substrate. Also in this case, the surface where the asymmetrical temperature distribution is produced can be formed on each of a substrate on a side in the channel where the light radiation unit is provided and a substrate on a side facing the side where the light radiation unit is provided.

The surface on which the asymmetrical temperature distribution is produced can be regarded as the surface having the light reflectivity distribution from the view point of reflection rather than absorption, although the meaning is the same as that of the distribution of the optical absorption coefficient. From this viewpoint, techniques such as selectively changing the surface roughness of the surface 41 of the substrate, selectively arranging metal films, controlling the surface roughness of the surface of the metal film can be adopted.

By using a substrate including a heat storage layer having a low thermal conductivity and a heat bath portion having a high thermal conductivity, heat can be effectively held when the light is radiated and heat can be quickly dissipated when the light radiation is turned off. This improves optical responsivity.

The liquid transport channel according to the present invention can be formed of a material generally used in the field of, for example, a micro-total analysis systems (μ-TAS).

Specifically, the channel can be formed of a material stable with respect to the liquid to be transported. Examples of such a material include, for example, an inorganic material such as SiO₂ and Si and polymeric resin such as fluorocarbon polymer, polyimide resin, and epoxy-based resin.

The present invention also includes a structure in which a surface where the asymmetrical temperature distribution is produced is formed in the liquid transport direction by the light radiation on the surface of the material of the channel.

The width and the depth of the section of the channel can be 10 μm to 1 mm from the viewpoint of allowing a fluid containing bio-particles to flow therethrough. However, it is not necessarily required. The width and the depth may be set in a range from 1 μm to 2000 μm.

In the present invention, a fluid that can be transported through the channel is a liquid which basically contains polar molecules containing charged components. Examples of the liquid include water and solutions containing various electrolytes.

In particular, as the ion-containing liquid, water, an electrolyte solution, an oily liquid containing ions, and so forth can be used.

For example, an NaCl aqueous solution (S=0.05 mV/K), an NaOH aqueous solution (S=−0.22 mV/K), HCl aqueous solution (S=0.21 mV/K), a tetra-butyl-ammonium (TBAN) aqueous solution (S=1.0 mV/K), or a TBAN dodecanol solution (S=7.2 mV/K) can be used. Here, S denotes the Seebeck coefficient, which represents a voltage induced per unit temperature difference.

Although a liquid having a large Seebeck coefficient S can be used, the liquid can be selected depending on the application.

The liquid may be a liquid that contains fats and oils and minute air bubbles contained in an electrolyte solution such as water or a liquid that contains organic and inorganic fine particles and colloidal particles.

In order to fabricate the liquid transport device according to the present invention, technologies such as a micro electro mechanical systems (MEMS) technology and lithography can be used for the channel as is the case with the micro channels used for the so-called micro-TAS and the like. Also, a laminating and pressing including machining processes can be used.

Hereafter, the present invention will be described in detail with specific embodiments. It is noted that, in the following description with reference to the drawings, the same elements illustrated in the drawings are denoted by the same reference numerals in principle, thereby redundant description is avoided as much as possible.

### First Embodiment

FIGS. 1 to 3B illustrate a liquid transport device according to a first embodiment.

Referring to FIG. 1, the substrate 40, the light radiation unit 10, and the channel 20 are provided. The light radiation unit 10 radiates light toward the substrate 40. The substrate 40 and the light radiation unit 10 face each other. The channel 20 is disposed between the substrate 40 and the light radiation unit 10 and allows the liquid 23 containing ions indicated as the positive ions 21 and the negative ions 22 to be transported therethrough.

Reference numeral 45 denotes the transparent substrate. The transparent substrate 45 and the light radiation unit 10 face the substrate 40, so that the surface 41 of the substrate 40 is irradiated with the light 13 emitted from the light radiation unit 10.

The surface 41 of the substrate 40 includes the surface portions 31 in each of which the asymmetrical temperature distribution is produced in the direction 24 in which the liquid 23 is intended to be transported by the light radiation from the light radiation unit 10. That is, the surface portions 31 each have the asymmetrical optical absorption coefficient distribution.

FIG. 2A is a schematic view illustrating the device illustrated in FIG. 1 in more detail. FIG. 2B is a schematic view illustrating the temperature distribution on the surface 41 of the substrate 40 receiving the light radiation 13.

Referring to FIG. 2B, the asymmetrical temperature distributions 35 corresponding to the surface portions 31 are illustrated.

In FIG. 2A, the electric double layer 15 (charges on the substrate surface attract the ions of the opposite sign) is formed by the Seebeck effect and the temperature distributions produced by the light radiation 13. Reference numerals 16a and 16b denote electric fields in tangent directions generated together with the electric double layer 15.

Reference numeral 19 denotes temperature gradient vectors at an initial stage generated due to the temperature distributions on the substrate surface. Reference numeral 24 denotes the direction in which the liquid is intended to be transported.

FIG. 3A is a schematic view illustrating FIG. 1 and FIG. 2A in more detail. FIG. 3B illustrates the temperature distributions on the surface 41 of the substrate 40 similarly to or in the same manner as FIG. 2B.

In FIG. 3A, reference numeral 27 denotes the direction of the net flow of the liquid generated in the channel by the light radiation. Reference numerals 28 and 29 respectively indicate the slip velocities (Vs) in the forward direction and the reverse direction generated by the light radiation.

The device of the present embodiment particularly includes the surface portions 31 in each of which the optical absorption coefficient distribution continuously varies in the direction 24 in which the liquid 23 is intended to be transported. The surface portions 31 are periodically arranged on the surface 41 of the substrate 40.

In the device of the present embodiment, electric fields due to the electrolyte Seebeck effect are induced in the liquid 23 by the light radiation 13 performed by the light radiation unit 10. This causes the ions contained in the liquid to move along the electric fields, thereby forming the electric double layer.

At the same time, the tangent electric fields in the proximity of the surface and the electric double layer interact with one another, thereby generating the flows. Thus, the device of the present embodiment is a fluid transport device that allows the net flow to be generated by the asymmetry of the temperature distributions.

In particular in the present embodiment, since the asymmetrical optical absorption distributions of the surface are utilized, a simple and cheap light source can be used as the light source.

Furthermore, by periodically arranging the surface portions 31 in each of which the asymmetrical temperature distribution is produced, an area to drive the liquid 23 is increased, thereby increasing the flow velocity.

The channel 20 of the device of the present embodiment is formed by the substrate 40, the transparent substrate 45, and a spacer member (not illustrated) having a thickness of 1 to 500 μm.

The transparent substrate 45 is formed of a glass substrate having a thickness of 1 mm.

Each of the surfaces 31 having the asymmetrical optical absorption coefficient distributions includes a region where the optical absorption coefficient linearly varies from a white portion having a width of W1 to a white-to-black portion having a width of W2. The white and white-to-black portions are formed by applying resin-based ink so as to have a thickness of about 0.1 to 100 μm while changing the percentages of white and black pigments contained in the resin-based ink.

Alternatively, the surface 31 may be fabricated by forming a layer having a continuously varying reflectivity on a uniform optical absorption layer or may be formed of a metal film formed of Cu, Au, Cr, or the like having a continuously varying thickness of from about 0 to 1 μm.

Here, although it is not illustrated, it is also possible that a heat holding layer that holds heat generated by the light radiation 13 (heat holding device) and a cooling layer (cooling device) are disposed inside (below) the surface 41 of the substrate 40.

In this case, heat generated when the light is radiated can be effectively utilized and heat can be quickly dissipated when the light radiation is turned off. This can improve optical responsivity.

Here, the heat holding layer can be a thin film layer (thickness of from 0.2 μm to 100 μm) having a low thermal conductivity (10 W/(mK) or less), and the cooling layer can be a thick film layer or a substrate (thickness of 100 μm or more) having a high thermal conductivity (10 W/(mK) or more).

As specific examples, an SiO₂ layer having a thickness of 1 μm and an Si substrate having a thickness of 0.7 mm can be used.

A laser light source of about 1 mW to 10 W is used as the light source of the light radiation unit 10.

For example, when a region of about 10 μm by 10 μm is irradiated by defocused light from a yttrium aluminum garnet (YAG) laser (1 to 100 mW) of a wavelength of 1064 nm, a light intensity I of about 10 to 1000 MW/m² can be obtained.

By adjusting an optical absorption coefficient g2 of the optical absorption regions 31 of the substrate surface 41 to a range from 0.1 to 1, a surface heating density Q′ of about 1 to 1000 MW/m² can be obtained. By using this, the asymmetrical temperature distributions of a temperature difference ΔT can be produced on the substrate surface 41.

Here, why the device of the present embodiment can generate the flow of the liquid will be theoretically described as follows.

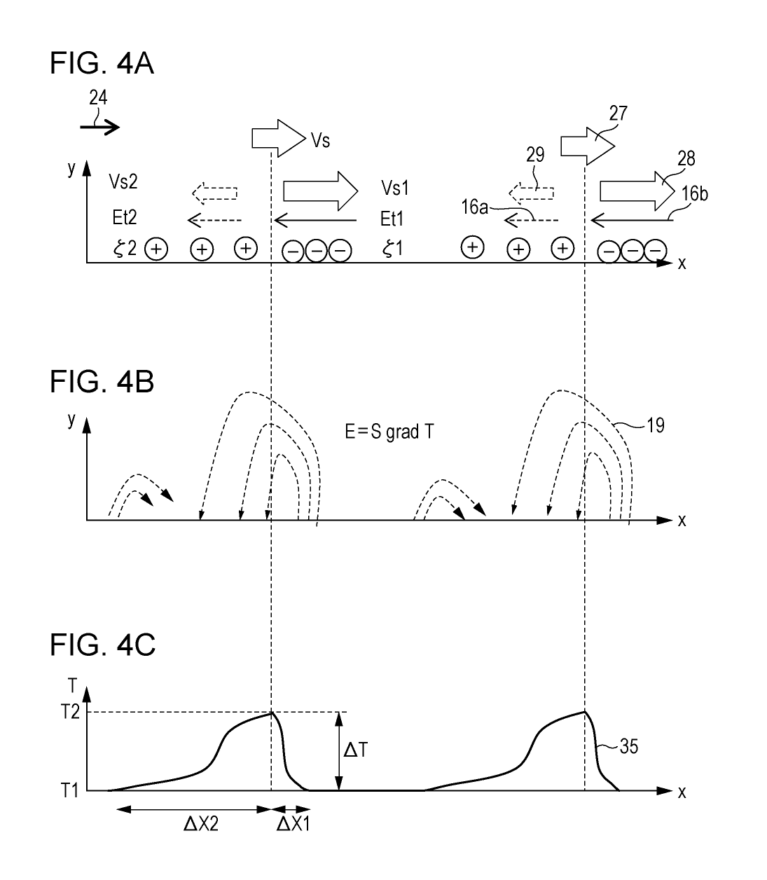

When the light 13 is radiated from the light radiation unit 10 illustrated in FIG. 1 toward the substrate surface 41, the asymmetrical temperature distributions 35 are produced corresponding to the surfaces 31 having the asymmetrical optical absorption coefficient distributions as illustrated in FIG. 4C.

In FIG. 4C, the distances from a position where a maximum peak temperature T2 is given to a minimum temperature value T1 measured in the x and −x directions are respectively represented as ΔX1 and ΔX2 (<ΔX1).

When the asymmetrical temperature distributions 35 illustrated in FIG. 4C are produced, the temperature gradient vectors 19 (grad T) directed from the low temperature portion to the high temperature portion are generated in the proximity of the substrate surface in the channel as illustrated in FIG. 4B. Due to these temperature gradients, the electric fields represented as E=S grad T induced by the electrolyte Seebeck effect are generated.

As a result, the positive ions and negative ions respectively move to the high temperature sides and the low temperature sides of the surface. Thus, as illustrated in FIG. 4A, the electric double layer characterized by ζ potentials (ζ1 and ζ2) and the electric fields Et (Et1 and Et2) in the tangent directions are generated on the substrate surface. The electric field components in the tangent directions are also denoted by 16a and 16b.

Thus, the slip velocities represented by the Helmholtz-Smoluchowski equation Vs=−εζEt/η are generated. Here, η represents the viscosity (1 mPa·s for water), ε represents the dielectric constant of a liquid 23 (when the dielectric constant of vacuum is ε₀, the dielectric constant of water ε=80ε₀).

Here, if the temperature distributions are each symmetric about a corresponding one of the peaks, the generated tangent potentials Et are the same, and accordingly, the ζ potentials on the left and right of the peak are the same in size and of opposite signs. Thus, the slip velocities of the same magnitude are generated on the left and right of the peak in different directions. Thus, the net flow cannot be obtained.

In contrast, when the temperature distributions are produced on the substrate surface such that each of the temperature distributions is asymmetrical about a corresponding one of the temperature peaks, the symmetry of the tangent potentials, the ζ potentials, and the slip velocities on the left and right is broken as illustrated in FIG. 4A, and accordingly, the net slip velocity and the flow 27 can be generated. Reference numerals 28 and 29 respectively denote the slip velocities (Vs1 and Vs2) in the forward and reverse directions. Reference numeral 24 denotes the direction in which the liquid is intended to be transported.

In FIG. 4C, the temperature difference between the maximum peak and the minimum value is represented by ΔT=T2−T1. Thus, the temperature gradient on the right side of the peak is about −ΔT/ΔX1 and the temperature gradient on the left side of the peak is about −ΔT/ΔX2.

In FIG. 4A, the tangent electric fields Et1 (16b) and Et2 (16a) on the right and left sides of each of the peaks are respectively −SΔT/ΔX1 and −SΔT/ΔX2.

Thus, the ζ potential on the right side of the peak is represented by ζ1=+S(ΔT/ΔX1)ΔX1=+SΔT and the ζ potential on the left side of the peak is represented by ζ2=−S(ΔT/ΔX2)ΔX2=−SΔT.

The slip velocity on the right side of the peak Vs1 is represented by Vs1=−ε(+SΔT)(−SΔT/ΔX1)/η=+ε(SΔT)²/(ΔX1η), and the slip velocity on the left side of the peak Vs2 is represented by Vs2=−ε(−SΔT)(−SΔT/ΔX2)/η=+ε(SΔT)²/(ΔX2η).

Since ΔX1<ΔX2, the slip velocity 28 on the right is higher than the slip velocity 29 on the left. Thus, the net slip velocity 27 represented by the following equation is generated: Vs=Vs1−Vs2=+ε(SΔT)²[(1/ΔX1η)−(1/ΔX2η)].

In particular, when ΔX1<<ΔX2, the second term of the above-described equation is negligible and Vs≈+ε(SΔT)²(1/ΔX1η).

When the TBAN aqueous solution is used as the liquid 23 containing the ions and ΔT=1K and ΔX=1 μm, the Seebeck coefficient S is S=1.0 mV/K. Thus, Vs≈+0.7 μm/s.

When ΔT=10, 40, and 80K under the same conditions, Vs≈+70, 1112 and 4480 μm/s. Here, η=1 mPa·s and ε=80ε₀.

Here, the slip velocity Vs (the net flow 27 of the liquid) is the characteristic velocity of the system. For the applications of the micro-TAS or the like, this value is used as a reference value in the design suitable for a purpose.

For example, in the design of a channel for a typical μ-TAS, a value about Vs≈0.1 mm/s can be used as a standard value for designing a DC electro-osmotic pump using several KV application.

An AC electroosmotic (ACEO) pump and an induced-charge electro-osmotic (ICEO) pump expected as a low-voltage high-velocity pump can be designed by using a Vs value about Vs≈1 mm/s as a standard value.

Likewise, a thermo-osmotic pump that utilizes the electric double layer and the surface tangent electric field suitable for a purpose can be designed by using Vs values of Vs≈+0.7, 70, 1112, and 4480 μm/s as characteristic values of the flow velocity.

By using the length L of the channel 20 (length in the x direction in FIG. 1), the width W (the distance between the substrate measured in the y direction in FIG. 1), the height H (the width of the channel in a direction perpendicular to the page of FIG. 1), and a parameter γ (<1) varying in accordance with the shape of the channel, the size, the shape, the position, and so forth of a surface affecting the slip velocity, an average flow velocity Up in the channel is expressed as follows:

Up=γVs.

The design suitable for a purpose is possible by referring this value.

### Second Embodiment

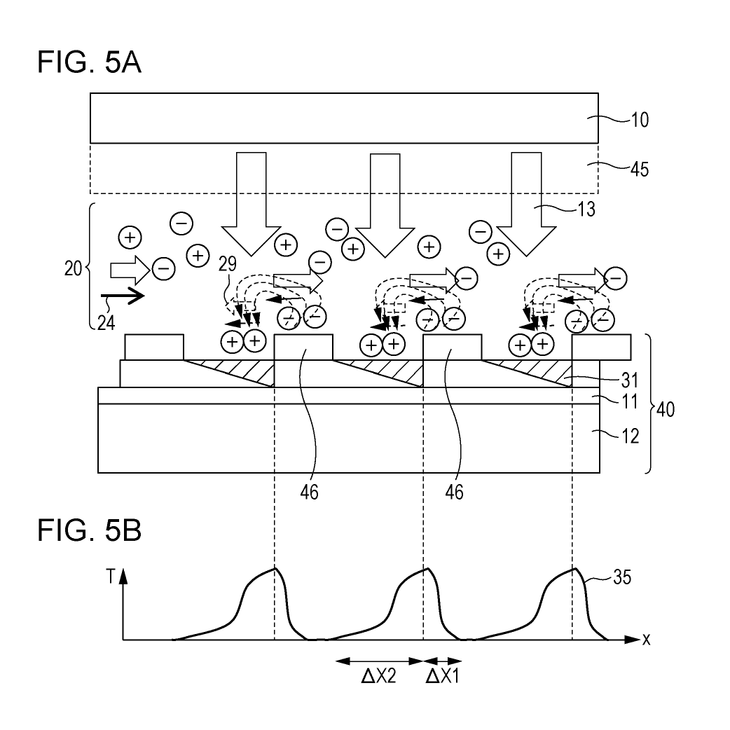

A liquid transport device of a second embodiment will be described with reference to FIGS. 5A and 5B.

Although a device of the present embodiment is structured similarly to the device of the first embodiment, there are main differences between these devices as follows: that is, in the device of the present embodiment, the substrate 40 used for the device of the present embodiment includes a surface that has irregularities 46 in a direction substantially perpendicular to the direction 24 in which the liquid is to be supplied, and a heat holding layer 11 that holds heat generated by the light radiation 13 is provided below the surface of the substrate 40. A cooling layer 12 is disposed below the heat holding layer 11.

By setting surfaces 31 where the asymmetrical temperature distributions are produced in recess portions of the irregularities 46, the flows derived from the slip velocity 29 (Vs2) generated in a direction opposite to the direction 24 in which the liquid is to be supplied are suppressed. This increases the net flow velocity.

The irregularities 46 can be a structure that strengthens the net flow by hydrodynamically suppressing one of the flows more than the other flow. A step structure, a porous structure, and so forth can be adopted as the irregularities 46.

The irregularities 46 illustrated in FIG. 5A have step structures having a low heat absorptivity arranged on the low temperature distribution sides of the surface. The step structures each have a rectangular sectional structure. The sectional structure may have any of various shapes such as a triangle, a polygon, and an L shape.

Furthermore, with the heat holding layer 11 and the cooling layer 12, heat generated when the light is radiated can be effectively utilized and heat can be quickly dissipated when the light radiation is turned off. This can improve optical responsivity.

The heat holding layer 11 can be a thin film layer (thickness of from 0.2 to 100 μm) having a low thermal conductivity (10 W/(mK) or less), and the cooling layer 12 can be a thick film layer or a substrate (thickness of 100 μm or more) having a high thermal conductivity (10 W/(mK) or more).

As specific examples, an SiO₂ layer having a thickness of 1 μm and an Si substrate having a thickness of 0.7 mm can be used.

### Third Embodiment

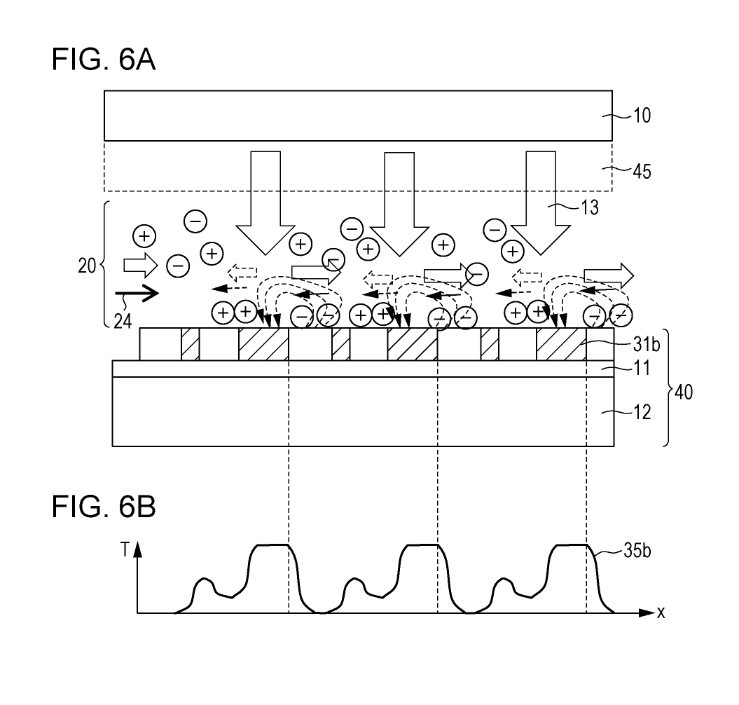

A liquid transport device of a third embodiment will be described with reference to FIGS. 6A and 6B.

Although a device of the present embodiment is structured similarly to the device of the first embodiment, there are main differences between these devices as follows: that is, in the device of the present embodiment, the surfaces 31b where the optical absorption coefficient distribution varies stepwise in the direction 24 in which the liquid is to be supplied are periodically provided, and the heat holding layer 11 and so forth illustrated in FIG. 5A are provided.

In the device of the present embodiment, the surfaces 31b where the asymmetrical optical absorption distributions vary stepwise are adopted so as to form the asymmetrical temperature distributions 35b. This can simplify the formation of the optical absorption layer.

The device illustrated in FIGS. 6A and 6B uses two optical absorption coefficients of white and black, and the area of black regions that are surface regions where the light is absorbed are varied. Thus, high optical absorption density regions and low optical absorption density regions are formed, thereby forming the asymmetry of the surface temperature distributions. This facilitates formation of a surface having asymmetrical optical absorption distributions.

There is a structure different from the above-described structure in which the fact that metal can be an optical absorption material on the short wavelength side is utilized. That is, a surface having the asymmetrical temperature distributions can be formed by arranging metal thin films of Au, Cu, Cr, W or the like as the optical absorption layer while varying the areas of the films.

### Fourth Embodiment

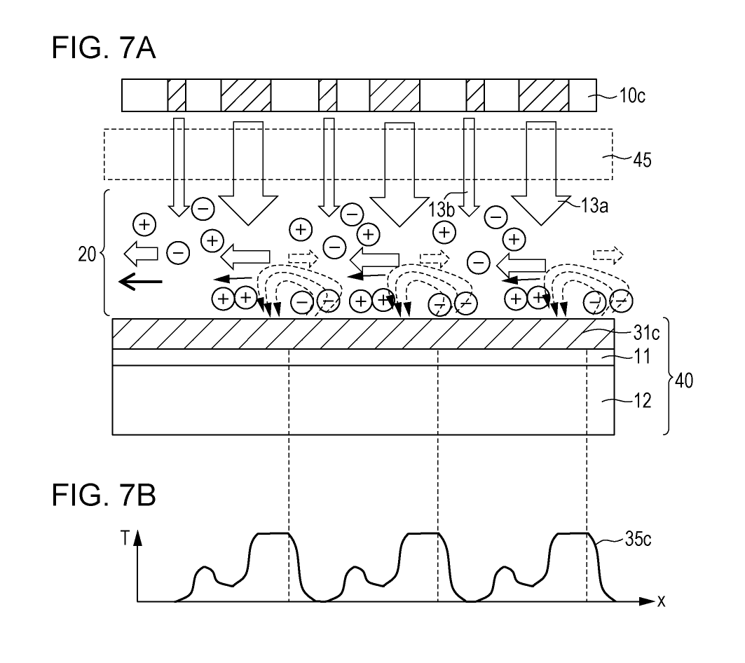

A liquid transport device of a fourth embodiment will be described with reference to FIGS. 7A and 7B.

Although a device of the present embodiment is structured similarly to the device of the third embodiment, there is a main difference between these device as follows: that is, in the device of the present embodiment, a light radiation unit 10c is adopted as the light source that can emit light having an asymmetrical optical intensity distribution in the direction in which the liquid is to be supplied.

In the device of the present embodiment, an optical absorption layer 31c on the substrate surface can be simplified, and the pattern of the light radiation and the direction of the asymmetry can be changed by using the two-dimensional light radiation unit 10c.

This allows the flow of the fluid to be comparatively freely formed in the channel 20 provided between the transparent substrate 45 and the substrate 40.

Here, as the light radiation unit 10c, which have the asymmetrical optical intensity distribution and the two-dimensional radiation pattern, any of the following light radiation unit can be adopted: that is, a light radiation unit having two-dimensionally arranged point sources of light, a light radiation unit driven in a time-sharing manner, a light radiation unit of, for example, a scanner, which scans laser light with a movable mirror, or the like.

Alternatively, a two-dimensional pattern light source in which uniform light sources and two-dimensionally arranged optical shutters are combined similarly to a display can be used.

Alternatively, by using a pulsed laser or a high-speed optical shutter so as to intermittently radiate light toward the surfaces 31, an increase in temperature in regions other than regions where heat is intended to be absorbed can be suppressed.

Since heat dissipation can be suppressed by reducing light radiation time, a large temperature difference can be given to minute regions. Thus, a large temperature gradient can be formed. This is useful for increasing the flow velocity.

### Fifth Embodiment

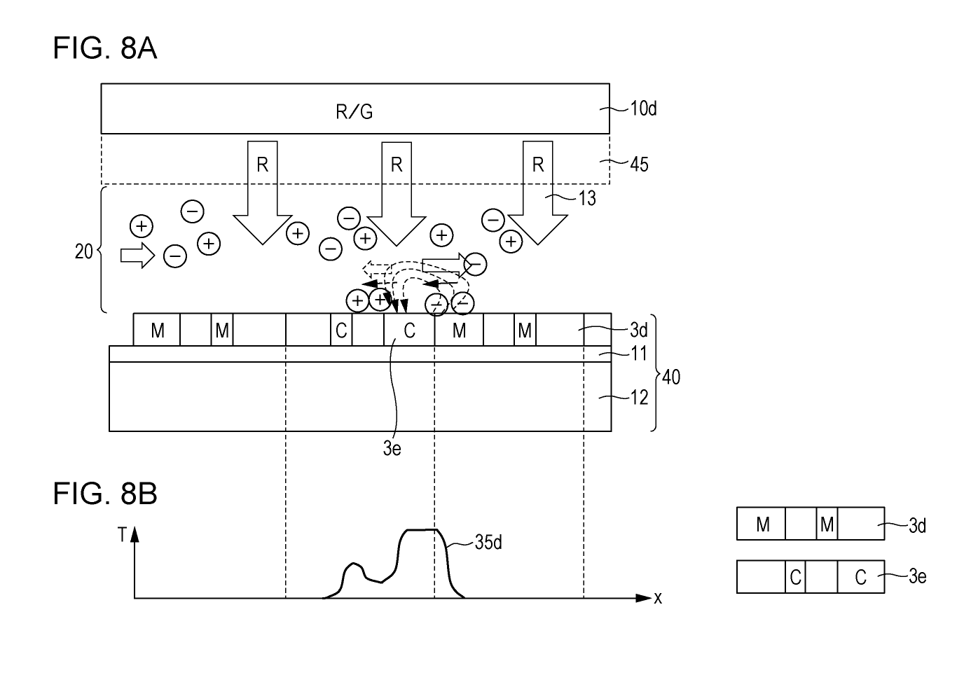

A liquid transport device of a fifth embodiment will be described with reference to FIGS. 8A and 8B.

Although the device of the present embodiment is structured similarly to the device of the third embodiment, there is a main difference as follows: that is, the device of the present embodiment includes, instead of the surfaces 31b described in the third embodiment where the asymmetrical optical absorption distributions vary stepwise, a plurality of asymmetrical optical absorption surfaces 3d and 3e which have respective different optical absorption wavelengths and a plurality of light sources 10d having wavelength characteristics corresponding the optical absorption wavelengths.

This device includes the surfaces 3e where cyan (C) is the absorber and the liquid supply direction is the x direction, the surfaces 3d where magenta (M) is the absorber and the liquid supply direction is the −x direction, and the light sources 10d that can radiate red (R) light and green (G) light corresponding to the surfaces. The surfaces 3e and the surfaces 3d are arranged in an alternating sequence.

When the red light is radiated, the asymmetrical temperature distributions in accordance with the cyan absorber are produced, thereby allowing the flow in the x direction to be generated, and when the green light is radiated, the asymmetrical temperature distributions in accordance with the cyan absorber are produced, thereby allowing the flow in the −x direction to be generated.

That is, by including the plurality of asymmetrical optical absorption surfaces 3d and 3e which have optical absorption wavelengths different from one another and the plurality of light sources 10d having the wavelength characteristics corresponding to the optical absorption wavelengths in the device of the present embodiment, when the radiation wavelength of the light source is switched, the flow can be selectively generated in accordance with corresponding surface portions.

In the liquid transport device according to the present invention, by radiating light from the light radiation unit toward the surface of the substrate disposed at a position in contact with the liquid containing ions, the asymmetrical temperature distributions are produced in the liquid transport direction. The asymmetrical temperature distributions cause the temperature distributions in the liquid. The electric fields are generated by the Seebeck effect caused by the temperature distributions. The movement of the ions in accordance with the electric fields forms the electric double layer. Thus, the drive force for the liquid is produced.

According to the present invention, the liquid transport device which does not need electrodes for applying voltage to the channel and wiring and the like for the electrodes, which has a simple structure, and which is small in size can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-067028, filed Mar. 27, 2014, which is hereby incorporated by reference herein in its entirety.

What is claimed is:

1. A liquid transport device comprising:
a channel through which a liquid containing ions is transported;
a substrate disposed at a position where the substrate is in contact with the liquid; and
a light radiation unit that radiates light toward the substrate,
wherein an asymmetrical temperature distribution in a direction in which the liquid is transported is produced on a surface of the substrate by the light radiated by the light radiation unit.

2. The liquid transport device according to claim 1,
wherein the surface of the substrate has an asymmetrical optical absorption coefficient distribution in the direction in which the liquid is transported.

3. The liquid transport device according to claim 2,
wherein a layer of a material different from a material of the substrate is selectively disposed on the surface of the substrate.

4. The liquid transport device according to claim 3,
wherein the layer of the material different from the material of the substrate includes a coloring material.

5. The liquid transport device according to claim 4,
wherein an amount of a color component of the coloring material is varied in the layer including the coloring material.

6. The liquid transport device according to claim 1,
wherein a temperature gradient is generated in the liquid in the channel by the temperature distribution on the surface of the substrate.

7. The liquid transport device according to claim 6,
wherein an electric field is generated by a Seebeck effect in accordance with the temperature gradient.

8. The liquid transport device according to claim 7,
wherein an electric double layer produced by the movement of the ions in accordance with the electric field produces a drive force for the liquid.

9. The liquid transport device according to claim 2,
wherein a plurality of the surfaces having the asymmetrical optical absorption coefficient distributions are provided on the substrate.

10. The liquid transport device according to claim 9,
wherein the plurality of surfaces having the asymmetrical optical absorption coefficient distributions are periodically provided.

11. The liquid transport device according to claim 2,
wherein the surface having the asymmetrical optical absorption coefficient distribution has irregularities.

12. The liquid transport device according to claim 1,
wherein the substrate includes a heat holding device.

13. The liquid transport device according to claim 1,
wherein the substrate includes a cooling device.

14. The liquid transport device according to claim 1,
wherein the light radiation unit emits light having an asymmetrical intensity distribution in the direction in which the liquid is transported, the light radiation unit emitting the light toward the surface of the substrate.

15. The liquid transport device according to claim 14,
wherein the light radiation unit includes point sources of light that are two-dimensionally arranged.

16. The liquid transport device according to claim 14,
wherein the light radiation unit scans laser light.
